(19) United States
(12) Patent Application Publication
(10) Pub. No.: US 2017/0195568 A1
(43) Pub. Date: Jul. 6, 2017

(54) Modular Panoramic Camera Systems

(71) Applicant: 360fly, Inc., Fort Lauderdale, FL (US)

(72) Inventors: Gustavo D. Leizerovich, JR., Aventura, FL (US); Michael Rondinelli, Canonsburg, PA (US); Claudio Santiago Ribeiro, Evanston, IL (US); Michael J. Harmon, Fort Lauderdale, FL (US); Felippe M. Bicudo, Fort Lauderdale, FL (US)

(21) Appl. No.: 15/399,655

(22) Filed: Jan. 5, 2017

Related U.S. Application Data
(60) Provisional application No. 62/275,328, filed on Jan. 6, 2016.

(51) Int. Cl. H04N 5/232; H02J 7/00; H04N 5/265; H04N 5/225; H04N 5/04

(52) U.S. Cl. CPC H04N 5/23238; H04N 5/2258; H04N 5/04; H04N 5/2252; H04N 5/23241; H04N 5/23293; H04N 5/265; H02J 7/0045

(57) ABSTRACT

A modular camera system includes two panoramic camera modules and a base module. Each camera module has a field of view larger than 180°, such that both camera modules are able to capture a combined 360° field of view. At least one (and optionally both) of the camera modules is releasably attached to the base module. The camera module that is releasably attached includes a processor operable to synchronize image data generated from the other camera module with image data generated by its own camera module to produce combined image data representing a 360° field of view. The other camera module may also include a processor, such that the two processors may be dynamically switchable between acting as a main processor and acting as a secondary processor. The base module may provide electrical connections for both camera modules and include a rechargeable battery and/or removable non-volatile memory for file storage.

### CROSS-REFERENCE TO RELATED APPLICATIONS

The present application claims priority, under 35 U.S.C. §119(e), upon U.S. Provisional Application No. 62/275,328, which application is incorporated herein in its entirety by this reference.

### TECHICAL FIELD

The present invention relates generally to panoramic camera systems and, more particularly, to modular panoramic camera systems.

### BACKGROUND

Various types of panoramic camera systems and virtual reality camera systems have been proposed. However, a need still exists for a versatile modular system that can generate high quality panoramic or virtual reality video and audio content.

### SUMMARY

An aspect of the present invention is to provide a modular panoramic camera system that includes a base module, a first panoramic camera module releasably attached to the base module, and a second panoramic camera module attached to the base module. The first panoramic camera module includes a processor operable to synchronize image data generated from the second panoramic camera module with image data generated by the first panoramic camera module to produce combined image data representing a 360° field of view.

This and other aspects of the present invention will be more apparent from the following description.

### BRIEF DESCRIPTION OF THE DRAWINGS

FIG. 1 is a schematic diagram of a modular panoramic camera system in accordance with an exemplary embodiment of the present invention.

FIG. 2 is a top isometric view of a modular panoramic camera system in accordance with another exemplary embodiment of the present invention.

FIG. 3 is a bottom isometric view of the modular panoramic camera system of FIG. 2.

FIG. 4 is a front view of the modular panoramic camera system of FIG. 1.

FIG. 5 is a side view of the modular panoramic camera system of FIG. 1.

FIG. 6 is an exploded assembly view of the modular panoramic camera system of FIG. 2.

FIG. 7 is an exploded assembly view of a modular panoramic camera system including a panoramic camera module and a pad, in accordance with an additional exemplary embodiment of the present invention.

FIG. 8 is an isometric view of an assembly including a panoramic camera module and a pad, in accordance with a further exemplary embodiment of the present invention.

FIG. 9 is an isometric view of the pad for the assembly of FIG. 8.

FIG. 10 is a side view of the pad for the assembly of FIG. 8.

FIG. 11 is an isometric view of an assembly including a panoramic camera module and an auxiliary base module, in accordance with an additional exemplary embodiment of the present invention.

FIG. 12 is an isometric exploded view of the assembly of FIG. 11.

FIG. 13 is a side view of the assembly of FIG. 11.

FIG. 14 is a bottom isometric view of the assembly of FIG. 11.

FIG. 15 is a side view of a lens for use in a panoramic camera module, in accordance with an exemplary embodiment of the present invention.

FIG. 16 is a side view of a lens for use in a panoramic camera module, in accordance with another exemplary embodiment of the present invention.

FIG. 17 is a side view of a lens for use in a panoramic camera module, in accordance with a further exemplary embodiment of the present invention.

FIG. 18 is a side view of a lens for use in a panoramic camera module, in accordance with yet another exemplary embodiment of the present invention.

FIG. 19 is a schematic flow diagram illustrating tiling and de-tiling processes, in accordance with an exemplary embodiment of the present invention.

FIG. 20 is a schematic flow diagram illustrating a camera side process, in accordance with an exemplary embodiment of the present invention.

FIG. 21 is a schematic flow diagram illustrating a user side process, in accordance with an exemplary embodiment of the present invention.

FIG. 22 is a schematic flow diagram illustrating a sensor fusion model, in accordance with an exemplary embodiment of the present invention.

FIG. 23 is a schematic flow diagram illustrating data transmission between a camera system and user, in accordance with an exemplary embodiment of the present invention.

FIGS. 24-26 illustrate interactive display features, in accordance with exemplary embodiments of the present invention.

FIGS. 27-29 illustrate orientation-based display features, in accordance with other exemplary embodiments of the present invention.

FIG. 30 illustrates two panoramic camera modules mounted on a drone, in accordance with an exemplary embodiment of the present invention.

### DETAILED DESCRIPTION

The present invention encompasses a modular camera system including two individual panoramic camera modules, each one with a field view larger than 180° such that both cameras are able to capture a combined 360° field of view (360 degrees in both the horizontal and vertical fields of view). The panoramic camera modules may be coupled together by a base module, which may include an interlocking plate and handle. The base module may provide electrical connections for both panoramic camera modules. The base module may also include a rechargeable battery that provides power to both panoramic camera modules, as well as removable non-volatile memory for file storage. Each panoramic camera module has its own wide field of view panoramic lens system and image sensor, as well as a processor that encodes video and/or still images.

Each camera module can generate an individual encoded video file, as well as an individual encoded audio file. The camera system may store the two video files separately, and the two audio files separately, in the file storage system and link them by the file name, or the individual files may be combined into a single image file and a single audio file for ease of file management at the expense of file processing. In order to synchronize both files at the frame level, one camera module may act as the master or main module and the other as the slave or secondary module. A frame synchronization connection from the main camera module to the secondary camera module may run through the interlocking plate of the base module. Processors contained in the separate camera modules may switch between acting as the main processor and acting as the secondary processor.

In certain embodiments, the individual panoramic camera modules may not contain a power source and/or file storage means. A separate module containing the power source and/or file storage may interlock with at least one of the individual panoramic camera modules transforming each module into a stand-alone unit capable of capturing panoramic images with a wide field of view, for example, 360° horizontal (about the lens' optical axis) by 240° vertical (along the lens' optical axis). The modular nature of such a system gives the user the flexibility of having a smaller single camera with a less than a full 360°×360° field of view, or reconfiguring the system into a larger fully capable 360°×360° camera system.

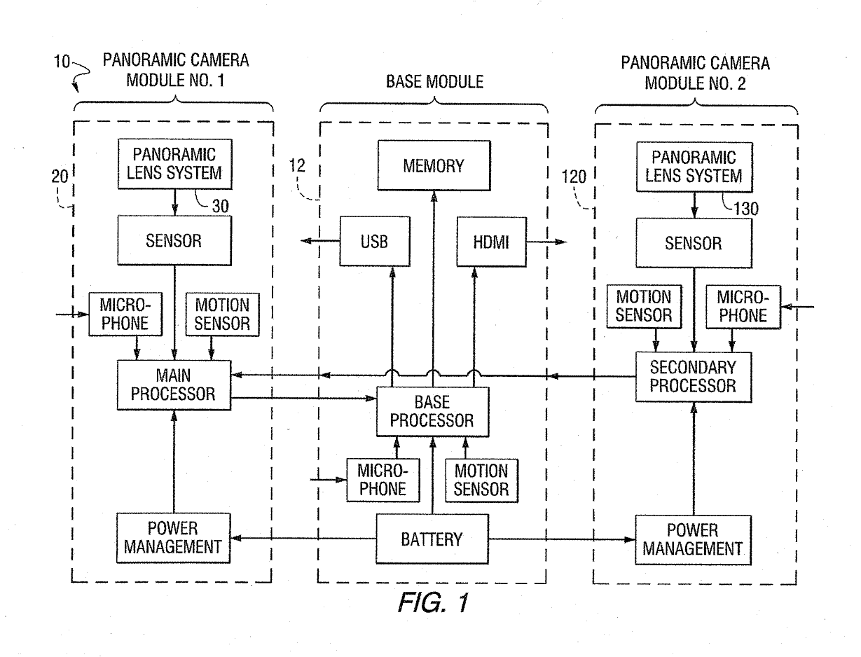

FIG. 1 is a schematic diagram illustrating a modular panoramic camera system 10 in accordance with one exemplary embodiment of the present invention. The modular panoramic camera system 10 includes a base module 12, a first panoramic camera module 20, and a second panoramic camera module 120. The base module 12 contains a base processor powered by a battery. A memory or storage device is connected to the base processor. Communication and data transfer connections may be made through the base processor, such as USB, HDMI, and the like.

As further shown in FIG. 1, the first panoramic camera module 20 includes a panoramic lens system 30, an image sensor, a master or main processor, and power management, which are described in more detail below. The second panoramic camera module 120 includes a panoramic lens system 130, an image sensor, a slave or secondary processor, and power management. As more fully described below, the processors of the first and second camera modules 20, 120 may remain in a master/slave configuration, or may be dynamically switchable between acting as the main processor and acting as the secondary processor. In certain embodiments, although each processor may be substantially identical, selection of the master or main processor may be initially determined and maintained (e.g., based upon the sequential serial number of each processor). Each of the camera modules 20, 120 may also include a microphone for capturing sound during operation. In the embodiment shown in FIG. 1, the main processor of the first camera module 20 communicates with the base processor of the base module 12 and also receives data from the secondary processor of the second camera module 120, as more fully described below. In the embodiment shown, the secondary processor of the second camera module 120 communicates directly with the main processor of the first camera module 20 via a high speed pass-through contained in the base module 12. Video image data and/or audio data from the second camera module 120 may thus be synchronized in the main processor of the first camera module 20 with video image data and/or audio data generated by the panoramic lens system 30, image sensor, and microphone of the first camera module 20.

The processor of the first camera module 20 and/or the processor of the second camera module 120 may be used to stitch together the image data from the first and second panoramic lens systems 30, 130 and image sensors. Any suitable technique may be used to stitch together the video image data from the first and second panoramic camera modules 20, 120. The large fields of view FOV₁ and FOV₂ of the first and second camera modules 20, 120 provide a significant region of overlap, and some or all of the overlapping region may be used in the stitching process. In certain embodiments, the stitching line may be at 180° (e.g., each of the first and second camera modules 20, 120 contribute a 180° field of view to provide the combined 360° field of view). Alternatively, one camera module may contribute a greater portion to the final 360° field of view than does the other camera module (e.g., the first camera module 20 may contribute a 240° field of view and the second camera module may contribute only a 120° field of view to the final combined 360°×360° video image). In certain embodiments, the stitch line may be adjusted to avoid having certain points of interest falling within the stitched region. For example, if a person's face is a point of interest within a video image, steps may be taken to avoid having the stitch line cover the person's face. Line cut algorithms may be used during the stitching process. A motion sensor, such as an accelerometer, may be used to record the orientation of the camera modules, and the recorded motion data may be used to adjust the stitch line.

The main processor of the first panoramic camera module 20 may also be used to combine or synthesize audio data from the first and second camera modules 20, 120. In one embodiment, the audio format can be a stereo format by using audio from the first camera module 20 as the right channel and audio from the second camera module 120 as the left channel. Generation of a stereo file thus can be accomplished through the first and second camera modules 20, 120 or, alternatively, through the base module 12 and one or both of the camera modules 20, 120. In another embodiment, the first and second camera modules 20, 120 may have multiple microphones, and a 3D audio experience can be created by combining the different audio channels according to 3D audio or full sphere surround sound techniques, such as ambisonics.

The stitched image data and combined audio data may be transferred from the main processor of the first camera module 20 to the base processor of the base module 12. The stitched image data may be stored by the base module's on-board memory storage device, which may be a removable storage device, and/or transmitted by any suitable means, such as a Universal Serial Bus (USB) port or a high-definition multimedia interface (HDMI) outlet, as shown in FIG. 1.

In certain embodiments, the processors of the two panoramic camera modules 20, 120 may switch between acting as the master or main processor and acting as the slave or secondary processor. Dynamic processor switching may be controlled based on various parameters, including the temperature of each processor or camera module 20, 120. For example, when one of the processors acts as the main processor, it may generate more heat than the other processor due to increased video stitching, audio synchronization, RF/Wi-Fi/Bluetooth functions, and the like. Furthermore, each camera module may record a different video image density, resulting in increased processor/module temperature of the camera module 20, 120 recording the larger image density. For example, the video images of one camera module 20, 120 may include more variation, movement, light intensity differences, etc., resulting in a larger temperature increase in that camera module 20, 120. As a particular example, one camera module (e.g., module 20) may capture a large portion of the sky with minor variation, movement or light intensity differences, while the other camera module (e.g., module 120) may record video images of higher variation, movement and/or light intensity differences. In this case, the camera module 20 capturing video images of the sky may experience a smaller temperature increase in comparison with the other camera module 120, and the main processing function may be switched to the cooler camera module 20 in order to balance heat generation between the camera modules 20, 120. In certain embodiments, the video images captured by one of the camera modules 20, 120 may be such that a reduced image data transfer rate may be used while maintaining sufficient image resolution (e.g., a normal rate of 30 frames per second may be decreased to a rate of 20 frames per second based on the video data content). Such a reduced data transfer rate may reduce the temperature of the respective camera module 20, 120, and the main processor function may be switched to the cooler camera module 20, 120 in order to balance the temperatures of the camera modules 20, 120.

In addition to the dynamic processor switching based upon video image data as described above, dynamic switching may also be based upon other parameters, including differences in audio capture between the camera modules 20, 120, and differences between communications/data transfer functionality of the modules 20, 120 (e.g., RF/Wi-Fi/Bluetooth functions). Thus, a camera module 20, 120 performing greater audio synthesis and/or greater RF/Wi-Fi/Bluetooth functions may be switched to the secondary processor in order to reduce unwanted temperature buildup in the camera module 20, 120. For example, RF signal conditions may be used to dynamically switch between the respective processors (e.g., the processor serving at the RF generator may be switched to the secondary processor in order to shift at least some of the temperature increase resulting from such RF functionality).

In certain embodiments, dynamic processor switching may be controlled by real-time performance characteristics of the respective processors. Such dynamic switching may thus be based upon changes in relative performance of each processor during use of the modular camera system 10 throughout its lifetime.

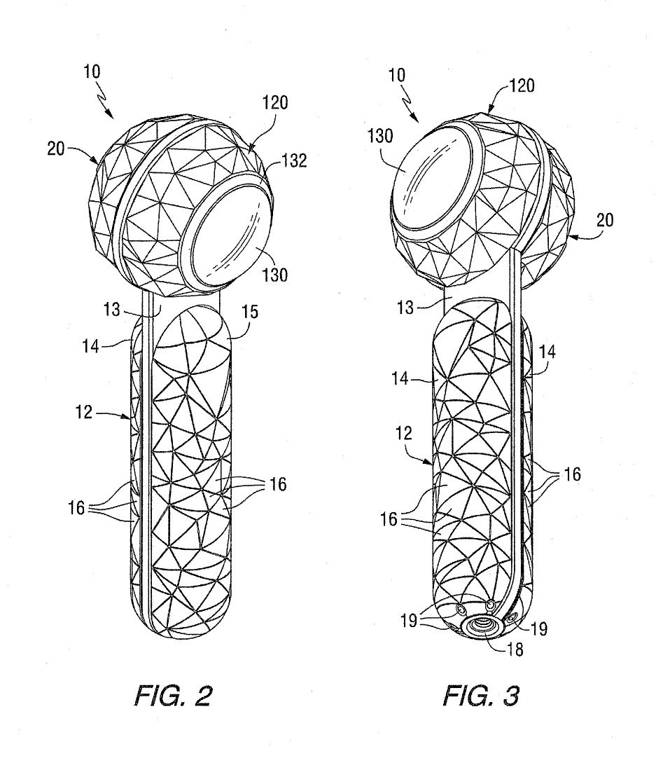

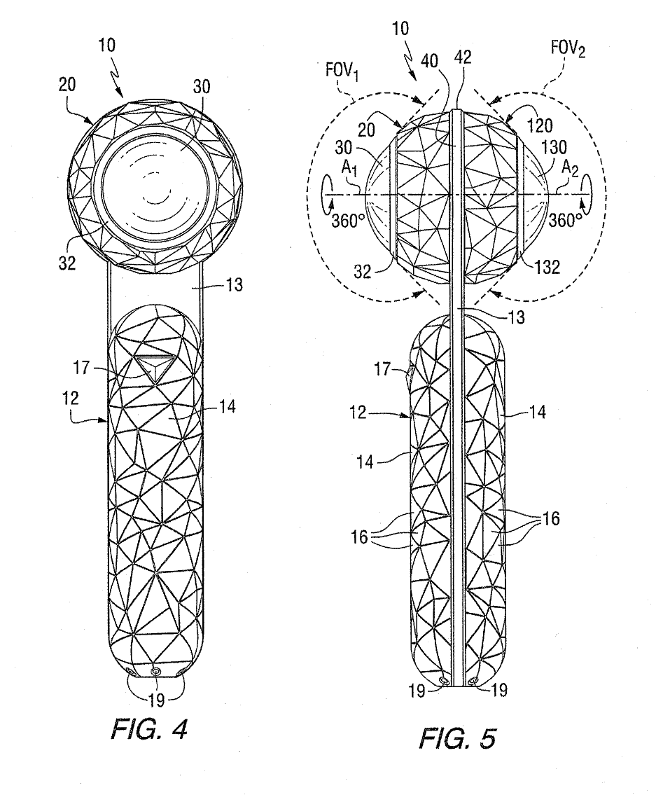

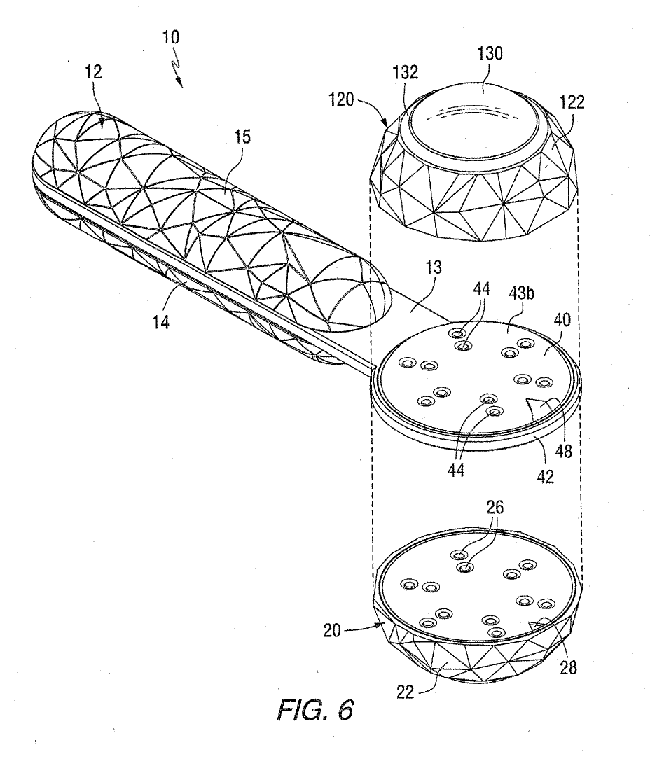

FIGS. 2-6 illustrate an exemplary embodiment of a modular panoramic camera system 10. The modular panoramic camera system 10 includes a base module 12 having a support strip 13, first grip portion 14, and second grip portion 15. The surfaces of the first and second grip portions 14, 15 may optionally have faceted shapes including multiple triangular facets 16. A power button 17 may be provided on the first grip portion 14. A battery may be provided at any suitable location in the base module 12. Any suitable type of battery or batteries may be used, such as conventional rechargeable lithium ion batteries and the like.

As shown most clearly in FIG. 3, a threaded mounting hole 18 may be provided at the bottom of the support strip 13 of the base module 12. The mounting hole may be of any desired configuration, including those of commercially available camera systems, such as those sold under the brands 360FLY and GOPRO. Multiple contact pins 19 may be included in each of the first and second grip portions 14, 15 adjacent to and surrounding the threaded mounting hole 18. The pins 19 can be used for USB connectivity and charging. A micro HDMI connector (not shown) may be used for video connectivity. The pins 19 may carry high speed pass-through connectivity, video, and synchronization signals, and may provide the connectivity shown in FIG. 1.

The exemplary modular panoramic camera system 10 of FIGS. 2-6 also includes a pair of panoramic camera modules 20, 120. The first panoramic camera module 20 includes a camera body 22 and an underface 24 with multiple mounting electrical contacts 26 located thereon. The electrical contacts 26 interface the camera module 20 to the base module 12. The first camera module 20 includes a panoramic lens 30 that is secured by a lens support ring 32. Features of the panoramic lens 30 are described in more detail below.

The support strip 13 of the base module 12 terminates in a support plate 40 that is substantially disk shaped. The support plate 40 has an outer peripheral edge 42, first face 43a and second face 43b. Several electrical contacts 44 are provided in each of the faces 43a, 43b of the support plate 40. The electrical contacts 44 in the support plate 40 interface with the electrical contacts 26 of the camera module 20 or modules 20, 120.

The second panoramic camera module 120 may be very similar to the first camera module 20 and include a camera body 122 and an underface with multiple mounting electrical contacts located thereon. The second camera module 120 may also include a panoramic lens 130 that is secured in the second camera body 122 by a second lens support ring 132. The panoramic lenses 30, 130 of the two camera modules 20, 120 may be the same in certain embodiments.

Each panoramic lens 30, 130 has a principle longitudinal axis (optical axis) A₁ and A₂ defining a 360° rotational view. Each panoramic lens 30, 130 also has a respective a field of view FOV₁, FOV₂ greater than 180° up to 360° (e.g., from 200° to 300°, from 210° to 280°, or from 220° to 270°. In certain embodiments, the fields of view of the panoramic lenses 30, 130 may be about 230°, 240°, 250°, 260° or 270°. The lens support rings 32, 132 may be beveled at an angle such that they do not interfere with the fields of view of the lenses 30, 130. When mounted on the base module 12, the first and second camera modules 20, 120 are offset 180° from each other with the longitudinal axes A₁, A₂ of their panoramic lenses 30, 130 aligned.

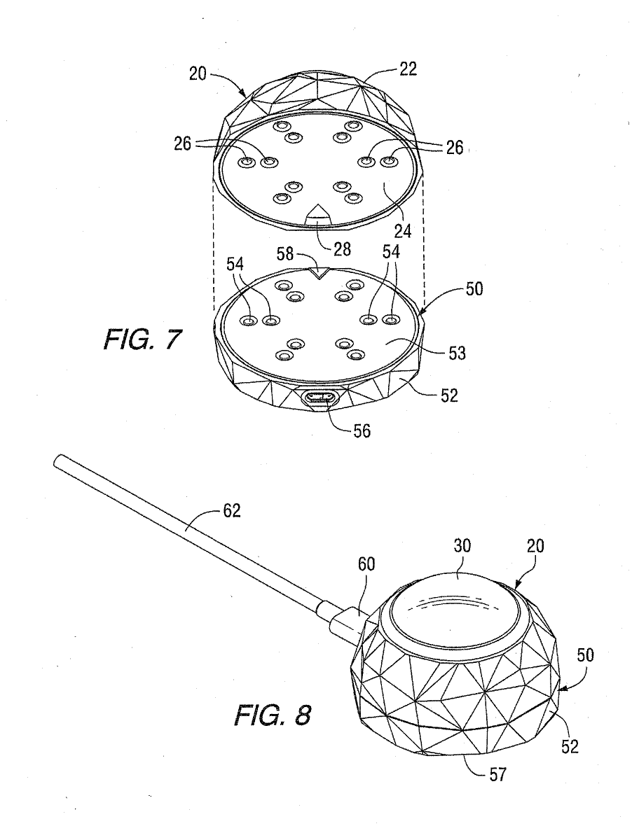

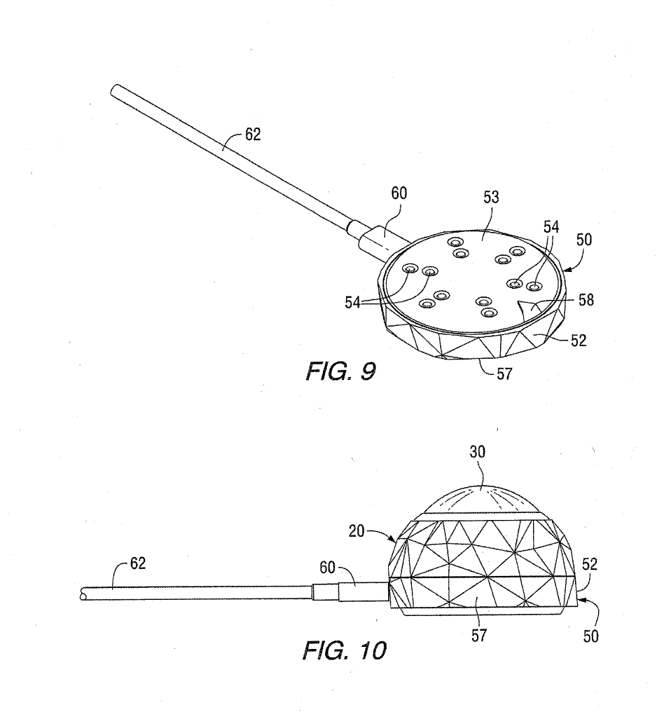

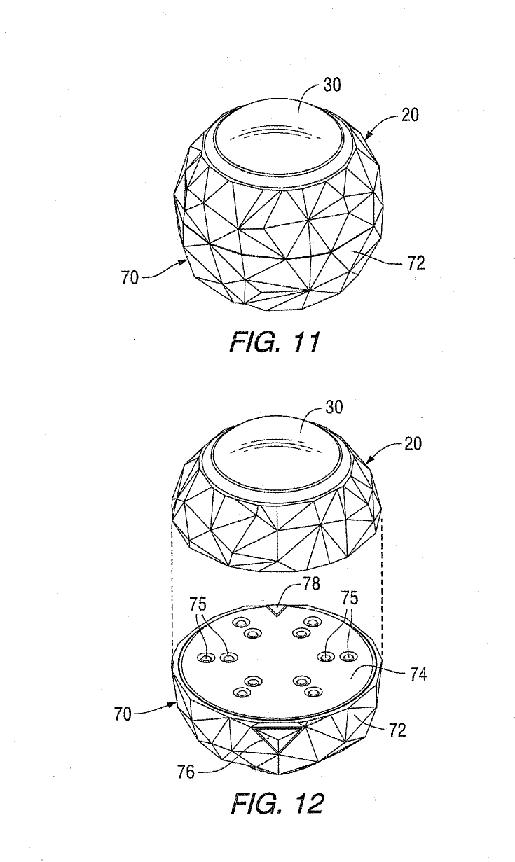

The first and second panoramic camera modules 20, 120 may be releasably mounted on the base module 12, a charging pad 50 (as described below with respect to FIGS. 7-10), or an auxiliary base module 70 (as described below with respect to FIGS. 11-14) by any suitable means, including mounting brackets and/or magnets. For example, the base module 12, the charging pad 50, or the auxiliary base module 70 may include centrally located mounting studs, and a mount attachment hole may be provided centrally in the back surface of each of the first and second panoramic camera modules 20, 120, as described in U.S. patent application Ser. No. 14/846,341 filed Sep. 4, 2015, which application is incorporated herein by this reference. Alternatively, the releasable mounting configuration may be structured such that the generally disk-shaped back face of each of the panoramic camera modules 20, 120 is configured in a similar manner as the lower base with spring-loaded mounting buttons disclosed in application Ser. No. 14/846,341, and the first and second faces 43a, 43b of the support plate 40 of the base module may be configured in a similar manner as the base plate 150 disclosed in application Ser. No. 14/846,341. Furthermore, a threaded hole may be provided centrally in the back surface of each of the panoramic camera modules 20, 120, which are threadingly engageable with threaded holes or posts in the base module 12, the charging pad 50, the auxiliary base module 70, or any other support structure.

In certain embodiments, the first and second panoramic camera modules 20, 120 may be secured directly to each other to form a generally spherical body with the lenses 30, 130 oriented 180° from each other and the lens' longitudinal axes aligned. This configuration provides a full 360° field of view without the use of the base module 12. In this configuration, there may be a need for an element between the camera modules 20, 120 to carry a battery.

The first panoramic camera module 20 may include a main processor board. A single board may contain the main processor, Wi-Fi, and Bluetooth circuits. The processor board may be located inside camera body 22 and/or camera body 122. Alternatively, separate processor, Wi-Fi, and Bluetooth boards may be used. Furthermore, additional functions may be added to such board(s), such as cellular communication and motion sensor functions, which are more fully described below. A vibration motor may also be provided in the first camera module 20, the second camera module 120, and/or base module 12.

Although certain features of the first panoramic camera module 20 are discussed in detail below, it is to be understood that the components of the second panoramic camera module 120 may be the same or similar. The panoramic lens 30 and its lens support ring 32 may be connected to a hollow mounting tube that is externally threaded. A video sensor 40 is located below the panoramic lens 30, and is connected thereto by means of a mounting ring 42 having internal threads engageable with the external threads of the mounting tube. The sensor 40 is mounted on a sensor board. The sensor 40 may comprise any suitable type of conventional sensor, such as CMOS or CCD imagers, or the like. For example, the sensor 40 may be a high-resolution sensor sold under the designation IMX117 by Sony Corporation. In certain embodiments, video data from certain regions of the sensor 40 may be eliminated prior to transmission (e.g., the corners of a sensor having a square surface area may be eliminated because they do not include useful image data from the circular image produced by the panoramic lens 30, and/or image data from a side portion of a rectangular sensor may be eliminated in a region where the circular panoramic image is not present). In certain embodiments, the sensor 40 may include an on-board or separate encoder. For example, the raw sensor data may be compressed prior to transmission (e.g., using conventional encoders such as jpeg, H.264, H.265, and the like). In certain embodiments, the sensor 40 may support three stream outputs such as: recording H.264 encoded .mp4 (e.g., image size 2880×2880); RTSP stream (e.g., image size 2880×2880); and snapshot (e.g., image size 2880×2880). However, any other desired number of image streams, and any other desired image size for each image stream, may be used.

A tiling and de-tiling process may be used in accordance with the present invention. Tiling is a process of chopping up a circular image of the sensor 40 produced from the panoramic lens 30 into pre-defined chunks to optimize the image for encoding and decoding for display without loss of image quality (e.g., as a 1080p image) on certain mobile platforms and common displays. The tiling process may provide a robust, repeatable method to make panoramic video universally compatible with display technology while maintaining high video image quality. Tiling may be used on any or all of the image streams, such as the three stream outputs described above. Tiling may be performed after the raw video is presented, then the file may be encoded with an industry standard H.264 encoding or the like. The encoded streams can then be decoded by an industry standard decoder on the user side. The image may be decoded and then de-tiled before presentation to the user. De-tiling can be optimized during the presentation process depending on the display that is being used as the output display. The tiling and de-tiling processes may preserve high quality panoramic images and optimize resolution, while minimizing processing required on both the camera side and the user side for lowest possible battery consumption and low latency. The image may be de-warped through use of de-warping software or firmware after the de-tiling process reassembles the image. The de-warped image may be manipulated by an application, such as a mobile or personal computer (PC) application, as more fully described below.

The main processor board of the first panoramic camera module 20 may function as the command and control center of the first and second panoramic camera modules 20, 120 to control video processing and stitching. Video processing may comprise encoding video using industry standard H.264 profiles, standard H.265 (HEVC) profiles, or the like to provide natural image flow with a standard file format.

Data storage may be accomplished in the base module 12 by writing data files to an SD memory card or the like, and maintaining a library system. Data files may be read from the SD card for preview and transmission. Wireless command and control may be provided. For example, Bluetooth commands may include processing and directing actions of the camera received from a Bluetooth radio and sending responses to the Bluetooth radio for transmission to the camera. Wi-Fi radio may also be used for transmitting and receiving data and video. Such Bluetooth and Wi-Fi functions may be performed with separate boards or with a single board. Cellular communication may also be provided (e.g., with a separate board, or in combination with any of the boards described above).

Any suitable type of microphone may be provided inside the first panoramic camera module 20, the second panoramic camera module 120, and/or the base module 12 to detect sound. For example, a 0.5 mm hole may be provided at any suitable location in the various module housings. The hole may couple to a conventional microphone element (e.g., through a water sealed membrane that conducts the audio sound pressure but blocks water). In addition to an internal microphone(s), at least one microphone may be mounted on the first panoramic camera module 20 and/or positioned remotely from the system. In the event that multiple channels of audio data are recorded from a plurality of microphones in a known orientation, the audio field may be rotated during playback to synchronize spatially with the interactive renderer display. The microphone output may be stored in an audio buffer and compressed before being recorded. In the event that multiple channels of audio data are recorded from a plurality of microphones in a known orientation, the audio field may be rotated during playback to synchronize spatially with the corresponding portion of the video image.

The first panoramic camera module 20, the second panoramic camera module 120 and/or the base module 12 may include one or more motion sensors (e.g., as part of the main processor in the first panoramic camera module 20, or as part of the base processer in the base module 12). As used herein, the term “motion sensor” includes sensors that can detect motion, orientation, position and/or location, including linear motion and/or acceleration, rotational motion and/or acceleration, orientation of the camera system (e.g., pitch, yaw, tilt), geographic position, gravity vector, altitude, height, and the like. For example, the motion sensor(s) may include accelerometers, gyroscopes, global positioning system (GPS) sensors, barometers, and/or compasses that produce data simultaneously with the optical and, optionally, audio data. Such motion sensors can be used to provide the motion, orientation, position and location information used to perform some of the image processing and display functions described herein. This data may be encoded and recorded. The captured motion sensor data may be synchronized with the panoramic visual images captured by first panoramic camera module 20, the second panoramic camera module 120, and/or the base module 12, and may be associated with a particular image view corresponding to a portion of the panoramic visual images (for example, as described in U.S. Pat. Nos. 8,730,322, 8,836,783 and 9,204,042).

Orientation based tilt can be derived from accelerometer data. This can be accomplished by computing the live gravity vector relative to the applicable camera module 20, 120 and/or the base module 12. The angle of the gravity vector in relation to the device along the device's display plane will match the tilt angle of the device. This tilt data can be mapped against tilt data in the recorded media. In cases where recorded tilt data is not available, an arbitrary horizon value can be mapped onto the recorded media. The tilt of the device may be used to either directly specify the tilt angle for rendering (i.e., holding the device vertically may center the view on the horizon), or it may be used with an arbitrary offset for the convenience of the operator. This offset may be determined based on the initial orientation of the device when playback begins (e.g., the angular position of the device when playback is started can be centered on the horizon).

Any suitable accelerometer may be used, such as conventional 3-axis and 9-axis accelerometers. For example, a 3 axis BMA250 accelerometer from BOSCH or the like may be used. A 3-axis accelerometer may enhance the capability of the camera to determine its orientation in 3D space using an appropriate algorithm. Either panoramic camera module 20, 120 may capture and embed raw accelerometer data into the metadata path in a MPEG-4 transport stream, providing the full capability of the information from the accelerometer that provides the user side with details to orient the image to the horizon.

The motion sensor may comprise a GPS sensor capable of receiving satellite transmissions (e.g., the system can retrieve position information from GPS data). Absolute yaw orientation can be retrieved from compass data, acceleration due to gravity may be determined through a 3-axis accelerometer when the computing device is at rest, and changes in pitch, roll and yaw can be determined from gyroscope data. Velocity can be determined from GPS coordinates and timestamps from the software platform's clock. Finer precision values can be achieved by incorporating the results of integrating acceleration data over time. The motion sensor data can be further combined using a fusion method that blends only the required elements of the motion sensor data into a single metadata stream or in future multiple metadata streams.

The motion sensor may comprise a gyroscope which measures changes in rotation along multiple axes over time, and can be integrated over time intervals (e.g., between the previous rendered video frame and the current video frame). For example, the total change in orientation can be added to the orientation used to render the previous frame to determine the new orientation used to render the current frame. In cases where both gyroscope and accelerometer data are available, gyroscope data can be synchronized to the gravity vector periodically or as a one-time initial offset. Automatic roll correction can be computed as the angle between the device's vertical display axis and the gravity vector from the device's accelerometer.

FIGS. 7-10 illustrate a pad 50 that may function as a base module in accordance with an alternative exemplary embodiment of the present invention. The pad 50 may include a processor that performs functions similar to the functions performed by the processor of the handle illustrated in FIGS. 2-6, but the pad processor may not perform video/synchronization exchange since there is only one camera module 20 in this embodiment. The pad 50 has a generally cylindrical sidewall 52, which may be faceted as shown in FIG. 7. The pad 50 has an upper generally disk-shaped planar surface 53 and a generally disk-shaped planar bottom surface 57. The upper surface 53 includes several electrical contact elements 54 that interface the camera module 20 to the pad 50. The contact elements 54 can transport data and/or power between the camera module 20 and the pad 50. The pad 50 may also include a USB data port 56, and a projection 58 that is receivable in a recess 28 in the bottom 24 of the camera module 20. The projection 58 and recess 28 may be used to align the camera module 20 in the desired rotational orientation on the pad 50. The data port 56 of the pad 50 may be configured to receive a data transfer plug 60, such as a USB plug. The plug 60 is connected to a power or data line 62.

FIGS. 11-14 illustrate an auxiliary base module 70 in accordance with another exemplary embodiment of the present invention. In this embodiment, the camera module 20 and the auxiliary base module 70 may include functionality as described in U.S. patent application Ser. No. 14/846,341, which is incorporated herein by reference. As described above, the camera module 20 includes a lens system, an image sensor, and a board with a processor, W-Fi, and Bluetooth. The auxiliary base module 70 may contain the battery, file storage, and an external connector, such as a micro HDMI connector (not shown). In one embodiment, the auxiliary base module 70 includes a generally hemispherical outer surface 72, which may be faceted as illustrated in FIG. 11. The auxiliary base module 70 has a generally disk-shaped planar upper surface 74 with several electrical contact elements 75 thereon. The electrical contacts 75 interface with the contacts of the camera module 20. The auxiliary base module 70 includes a power button 76 and a projection 78 receivable in the recess 28 of the panoramic camera module 20 for alignment therewith.

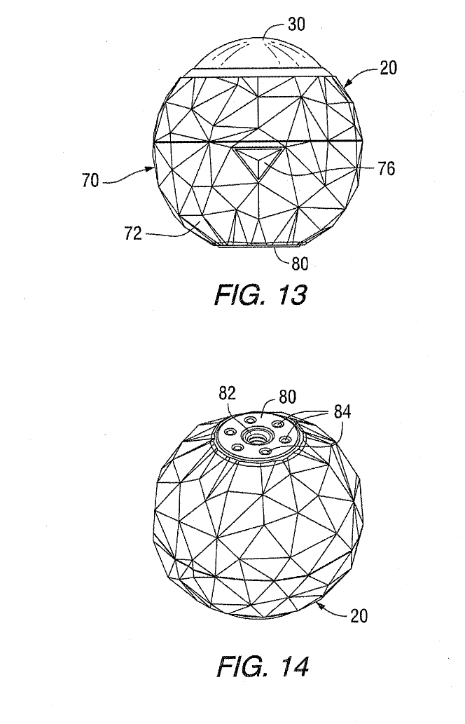

As shown in FIGS. 13 and 14, the auxiliary base module 70 has a substantially planar bottom surface 80 with a central mounting hole 82 therein. Although the mounting hole 82 is shown as being threaded in FIG. 14, it is to be understood that any other configuration may be provided to allow mechanical attachment of the auxiliary base module 70 to various types of mounting brackets, mounting adapters, and the like. Several contact pins 84 surround the mounting hole 82. The pins 84 may provide USB connectivity and charging.

Instead of being mounted to the base module 12, charging pad 50, or auxiliary base module 70 described above, the panoramic camera modules 20, 120 may be mounted on any other suitable support structure, such as vehicles, aircraft, drones, watercraft and the like. For example, a single panoramic camera module may be mounted on the underside of a drone with its longitudinal axis pointing downward or in any other desired direction. Multiple panoramic camera modules may be mounted on vehicles, aircraft, drones, watercraft and other support structures. For example, two panoramic camera modules may be mounted on a drone with their longitudinal axes aligned (e.g., one module with its longitudinal axis pointing vertically downward and the other module with its longitudinal axis pointing vertically upward, or in any other desired directions, such as horizontal, etc.).

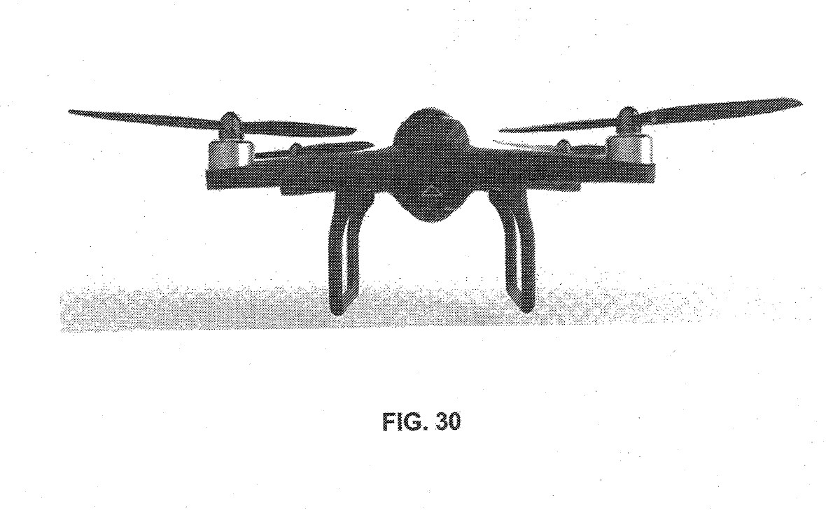

FIG. 30 illustrates an embodiment of a double panoramic camera system used on a drone. One panoramic camera module may be mounted on top of the drone to capture the sky above and another panoramic camera module may be mounted on the bottom of the drone to capture events taking place on earth or otherwise below the drone. It may be counterintuitive to have a camera on the top of a drone since views of the sky may not change significantly. However, a top-mounted panoramic camera module can capture static objects such as ceilings, light posts, etc., and dynamic items flying above the drone. As an example, the top panoramic camera module can visually identify other drones, birds, planes, etc. flying above the drone. For smaller drones that are designed for indoor use, the top-mounted panoramic camera module can capture ceilings and items hanging from the ceilings. In addition to capturing images of the items above, the processor in the panoramic camera module(s) or in a base module can use auto detection to identify the items and attempt to communicate with them. For example, a panoramic camera module on one drone may identify that another drone is flying too close above it. In such a scenario, the two drones can go through a handshake and start to communicate with each other and start a short autonomous flight until a safe separation distance is reached. The identification of one drone by another could be via a special identifier on each drone, such as a visible/light bar code (which can be encrypted), IR detection, or an RF beacon that can turn on when another object is detected.

In another example, the top panoramic camera module of a drone flying in a particular pattern below objects in the street or tunnels (e.g., light posts) can identify the lights that are out. The top panoramic camera module can also identify objects visually and take steps to avoid them. Object recognition software may be used and drones can become more autonomous with panoramic cameras giving them a higher opportunity to identify objects around them. For better identification, the drone can move on its flying angles to improve the capture of particular images and/or to better identify objects.

Such uses may be augmented with night vision or infrared technology. In addition to airborne uses on drones or other vehicles, the panoramic camera modules may be used on watercraft such, as ships and submarines. For example, the panoramic camera modules may be mounted on or in a submarine and may be designed to travel under water (e.g., the panoramic camera modules may be watertight at the water depths encountered during use).

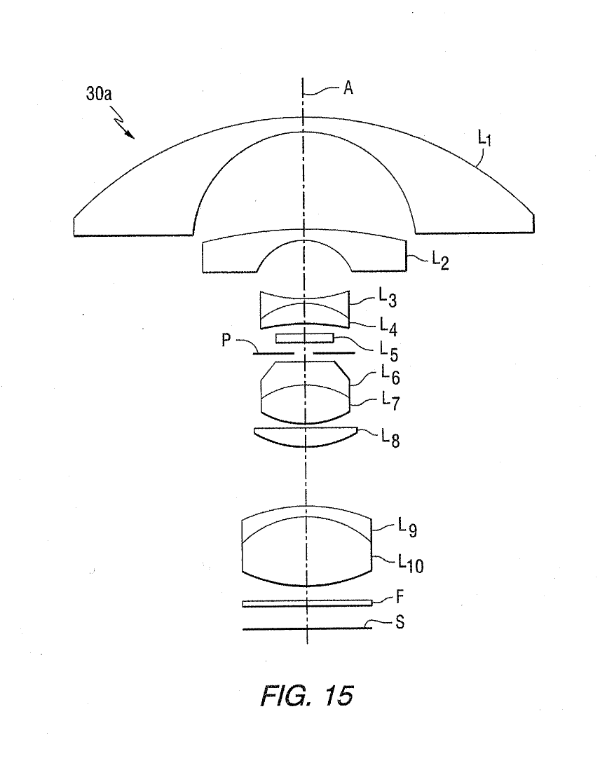

In accordance with embodiments of the present invention, the panoramic lenses 30, 130 may comprise transmissive hyper-fisheye lenses with multiple transmissive elements (e.g., dioptric systems); reflective mirror systems (e.g., panoramic mirrors as disclosed in U.S. Pat. Nos. 6,856,472; 7,058,239; and 7,123,777, which are incorporated herein by reference); or catadioptric systems comprising combinations of transmissive lens(es) and mirror(s). In certain embodiments, each panoramic lens 30, 130 comprises various types of transmissive dioptric hyper-fisheye lenses. Such lenses may have fields of view as described above, and may be designed with suitable F-stop speeds. F-stop speeds may typically range from f/1 to f/8, for example, from f/1.2 to f/3. As a particular example, the F-stop speed may be about f/2.5. Examples of panoramic lenses are schematically illustrated in FIGS. 15-18.

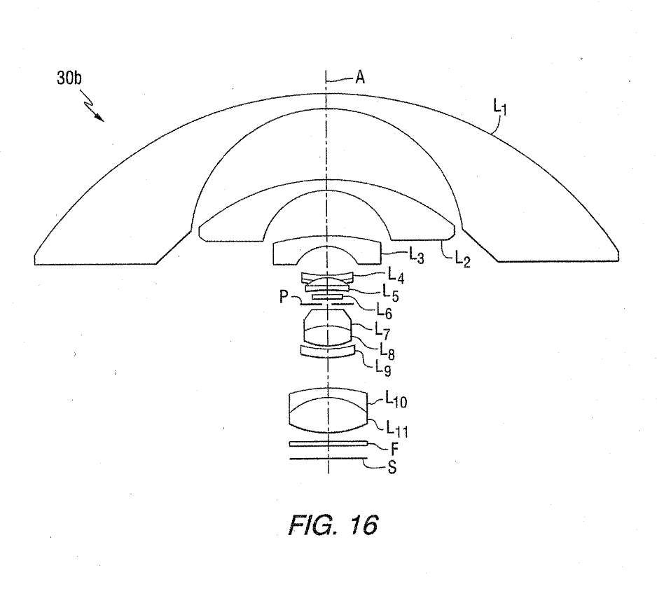

FIGS. 15 and 16 schematically illustrate panoramic lens systems 30a, 30b similar to those disclosed in U.S. Pat. No. 3,524,697, which is incorporated herein by reference. The panoramic lens 30a shown in FIG. 15 has a longitudinal axis A and comprises ten lens elements L₁-L₁₀. In addition, the panoramic lens system 30a includes a plate P with a central aperture, and may be used with a filter F and an image sensor S. The filter F may comprise any conventional filter(s), such as infrared (IR) filters and the like. The panoramic lens system 30b shown in FIG. 16 has a longitudinal axis A and comprises eleven lens elements L₁-L₁₁. In addition, the panoramic lens system 30b includes a plate P with a central aperture, and is used in conjunction with a filter F and sensor S.

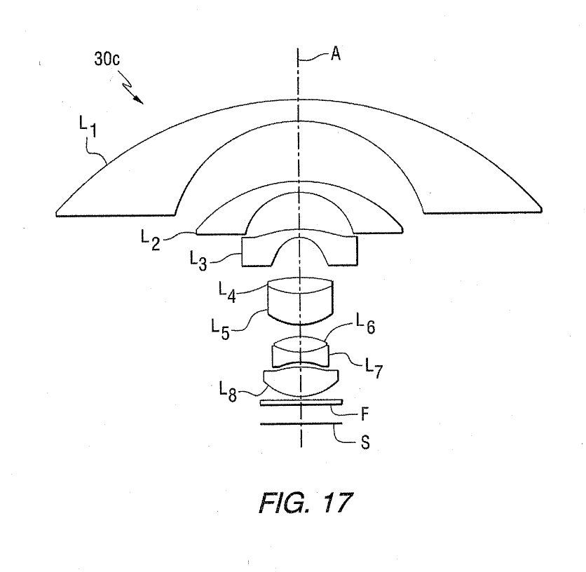

In the embodiment shown in FIG. 17, the panoramic lens assembly 30c has a longitudinal axis A and includes eight lens elements L₁-L₈. In addition, a filter F and sensor S may be used in conjunction with the panoramic lens assembly 30c.

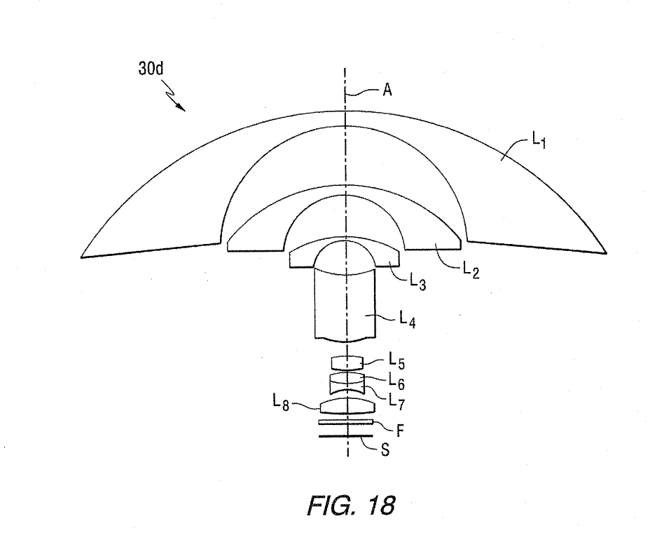

In the embodiment shown in FIG. 18, the panoramic lens assembly 30d has a longitudinal axis A and includes eight lens elements L₁-L₈. In addition, a filter F and sensor S may be used in conjunction with the panoramic lens assembly 30d.

In each of the panoramic lens assemblies 30a-30d shown in FIGS. 15-18, as well as any other type of panoramic lens assembly that may be selected for use in the panoramic camera modules 20, 120, the number and shapes of the individual lens elements L may be routinely selected by those skilled in the art. Furthermore, the lens elements L may be made from conventional lens materials, such as glass and plastics known to those skilled in the art.

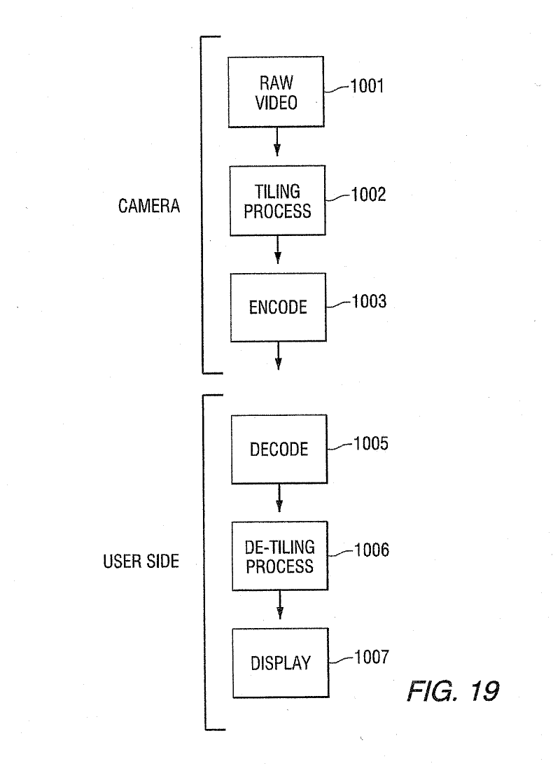

FIG. 19 illustrates an example process for processing video or other audiovisual content captured by a device, such as various embodiments of camera systems described herein. Various processing steps described herein may be executed by one or more algorithms or image analysis processes embodied in software, hardware, firmware, or other suitable computer-executable instructions, as well as a variety of programmable appliances or devices. As shown in FIG. 19, from the camera system perspective, raw video content can be captured at processing step 1001 by a user employing the modular camera system 10, for example. At step 1002, the video content can be tiled, or otherwise subdivided into suitable segments or sub-segments, for encoding at step 1003. The encoding process may include a suitable compression technique or algorithm and/or may be part of a codec process, such as one employed in accordance with the H.264 or H.265 video formats, for example, or other similar video compression and decompression standards. From the user perspective, at step 1005, the encoded video content may be communicated to a user device, appliance, or video player, for example, where it is decoded or decompressed for further processing. At step 1006, the decoded video content may be de-tiled and/or stitched together for display at step 1007. In various embodiments, the display may be part of a smart phone, a computer, video editor, video player, and/or another device capable of displaying the video content to the user.

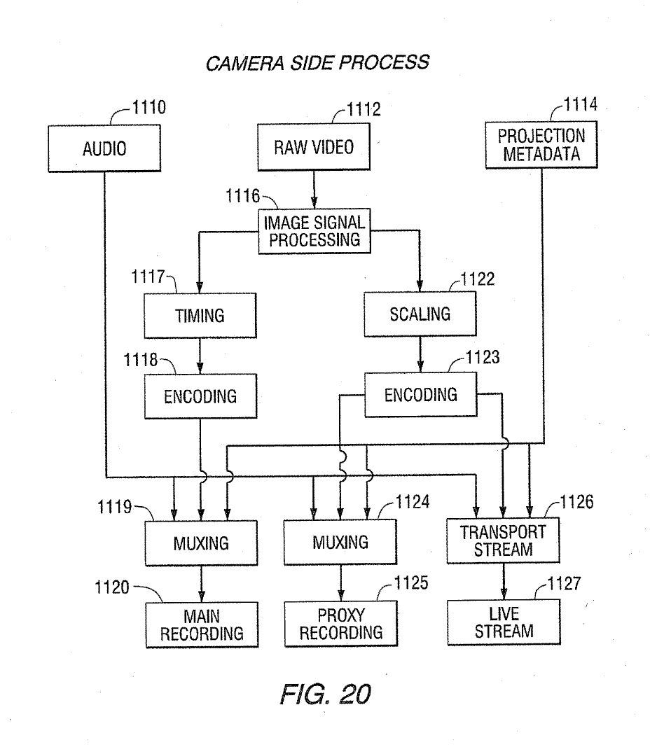

FIG. 20 illustrates various examples from the camera perspective of processing video, audio, and metadata content captured by a device, which can be structured in accordance with various embodiments of the camera systems described herein. At step 1110, an audio signal associated with captured content may be processed which is representative of noise, music, or other audible events captured in the vicinity of the camera. At step 1112, raw video associated with video content may be collected representing graphical or visual elements captured by the camera device. At step 1114, projection metadata may be collected which comprise motion detection data, for example, or other data which describe the characteristics of the spatial reference system used to geo-reference a video data set to the environment in which the video content was captured. At step 1116, image signal processing of the raw video content (obtained from step 1112) may be performed by applying a timing process to the video content at step 1117, such as to determine and synchronize a frequency for image data presentation or display, and then encoding the image data at step 1118. In certain embodiments, image signal processing of the raw video content (obtained from step 1112) may be performed by scaling certain portions of the content at step 1122, such as by a transformation involving altering one or more of the size dimensions of a portion of image data, and then encoding the image data at step 1123.

At step 1119, the audio data signal from step 1110, the encoded image data from step 1118, and the projection metadata from step 1114 may be multiplexed into a single data file or stream as part of generating a main recording of the captured video content at step 1120. In other embodiments, the audio data signal from step 1110, the encoded image data from step 1123, and the projection metadata from step 1114 may be multiplexed at step 1124 into a single data file or stream as part of generating a proxy recording of the captured video content at step 1125. In certain embodiments, the audio data signal from step 1110, the encoded image data from step 1123, and the projection metadata from step 1114 may be combined into a transport stream at step 1126 as part of generating a live stream of the captured video content at step 1127. It can be appreciated that each of the main recording, proxy recording, and live stream may be generated in association with different processing rates, compression techniques, degrees of quality, or other factors which may depend on a use or application intended for the processed content.

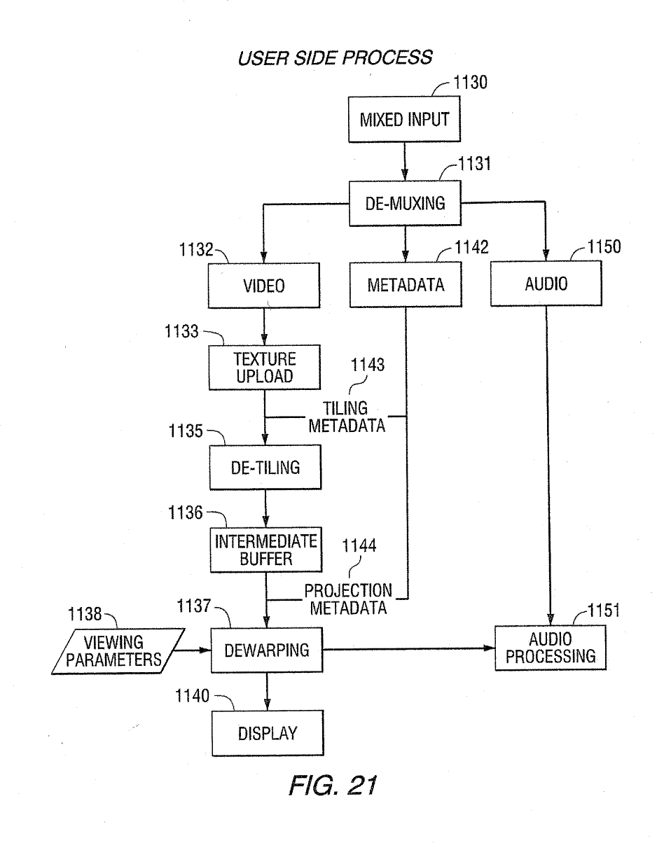

FIG. 21 illustrates various examples from the user perspective of processing video data or image data processed by and/or received from a camera device. Multiplexed input data received at step 1130 may be de-multiplexed or de-muxed at step 1131. The de-multiplexed input data may be separated into its constituent components including video data at step 1132, metadata at step 1142, and audio data at step 1150. A texture upload process may be applied in association with the video data at step 1133 to incorporate data representing the surfaces of various objects displayed in the video data, for example. At step 1143, tiling metadata (as part of the metadata of step 1142) may be processed with the video data, such as in conjunction with executing a de-tiling process at step 1135, for example. At step 1136, an intermediate buffer may be employed to enhance processing efficiency for the video data. At step 1144, projection metadata (as part of the metadata of step 1142) may be processed along with the video data prior to de-warping the video data at step 1137. De-warping the video data may involve addressing optical distortions by remapping portions of image data to optimize the image data for an intended application. De-warping the video data may also involve processing one or more viewing parameters at step 1138, which may be specified by the user based on a desired display appearance or other characteristic of the video data, and/or receiving audio data processed at step 1151. The processed video data may then be displayed at step 1140 on a smart phone, a computer, video editor, video player, virtual reality headset and/or another device capable of displaying the video content.

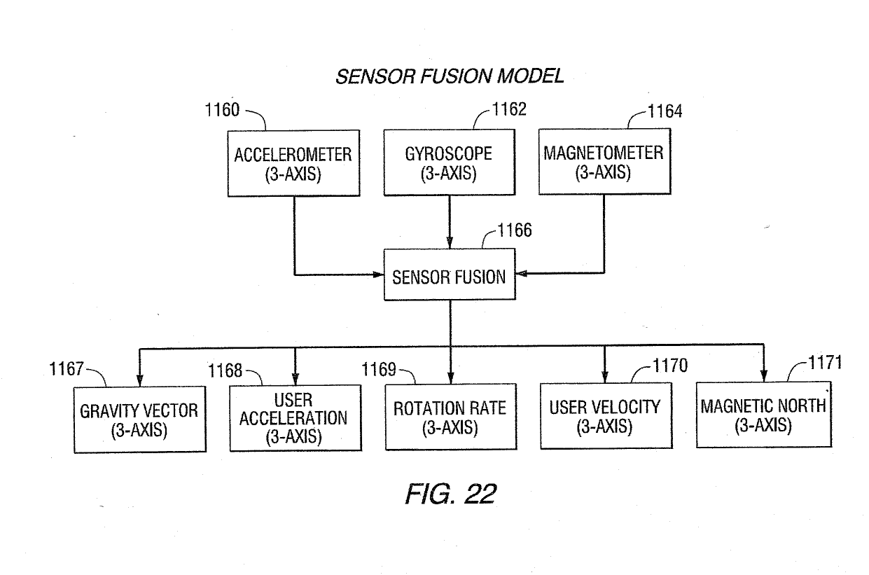

FIG. 22 depicts an example of a sensor fusion model which can be employed in connection with various embodiments of the devices and processes described herein. As shown, a sensor fusion process 1166 receives input data from one or more of an accelerometer 1160, a gyroscope 1162, or a magnetometer 1164, each of which may be a three-axis sensor device, for example. Those skilled in the art can appreciate that multi-axis accelerometers 1160 can be configured to detect magnitude and direction of acceleration as a vector quantity, and can be used to sense orientation (e.g., due to direction of weight changes). The gyroscope 1162 can be used for measuring or maintaining orientation, for example. The magnetometer 1164 may be used to measure the vector components or magnitude of a magnetic field, wherein the vector components of the field may be expressed in terms of declination (e.g., the angle between the horizontal component of the field vector and magnetic north) and the inclination (e.g., the angle between the field vector and the horizontal surface). With the collaboration or fusion of these various sensors 1160, 1162, 1164, one or more of the following data elements can be determined during operation of the camera device: gravity vector 1167, user acceleration 1168, rotation rate 1169, user velocity 1170, and/or magnetic north 1171.

The images from the camera system 10 may be displayed in any suitable manner. For example, a touch screen may be provided to sense touch actions provided by a user. User touch actions and sensor data may be used to select a particular viewing direction, which is then rendered. The device can interactively render the texture mapped video data in combination with the user touch actions and/or the sensor data to produce video for display. The signal processing can be performed by a processor or processing circuitry.

Video images from the camera system 10 may be downloaded to various display devices, such as a smart phone using an app, or any other current or future display device. Many current mobile computing devices, such as the iPhone, contain built-in touch screen or touch screen input sensors that can be used to receive user commands. In usage scenarios where a software platform does not contain a built-in touch or touch screen sensor, externally connected input devices can be used. User input such as touching, dragging, and pinching can be detected as touch actions by touch and touch screen sensors though the usage of off the shelf software frameworks.

User input, in the form of touch actions, can be provided to the software application by hardware abstraction frameworks on the software platform. These touch actions enable the software application to provide the user with an interactive presentation of prerecorded media, shared media downloaded or streamed from the internet, or media which is currently being recorded or previewed.

An interactive renderer may combine user input (touch actions), still or motion image data from the camera (via a texture map), and movement data (encoded from geospatial/orientation data) to provide a user controlled view of prerecorded media, shared media downloaded or streamed over a network, or media currently being recorded or previewed. User input can be used in real time to determine the view orientation and zoom. As used in this description, “real time” means that the display shows images at essentially the same time the images are being sensed by the device (or at a delay that is not obvious to a user) and/or the display shows images changes in response to user input at essentially the same time as the user input is received. By combining the panoramic camera with a mobile computing device, the internal signal processing bandwidth can be sufficient to achieve the real-time display.

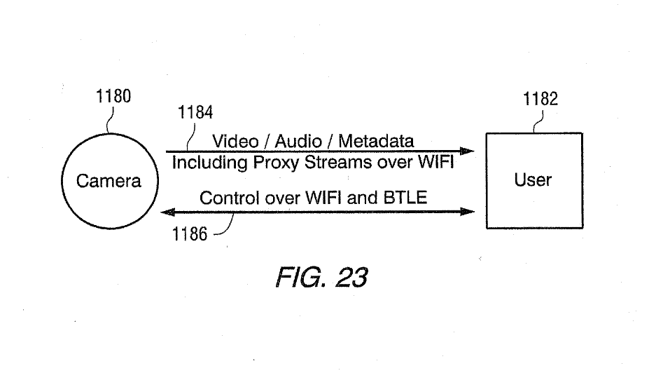

FIG. 23 illustrates an example interaction between a camera device 1180 and a user 1182 of the camera 1180. As shown, the user 1182 may receive and process video, audio, and metadata associated with captured video content with a smart phone, computer, video editor, video player, virtual reality headset and/or another device. As described above, the received data may include a proxy stream which enables subsequent processing or manipulation of the captured content subject to a desired end use or application. In certain embodiments, data may be communicated through a wireless connection (e.g., a Wi-Fi or cellular connection) from the camera 1180 to a device of the user 1182, and the user 1182 may exercise control over the camera 1180 through a wireless connection (e.g., Wi-Fi or cellular) or near-field communication (e.g., Bluetooth).

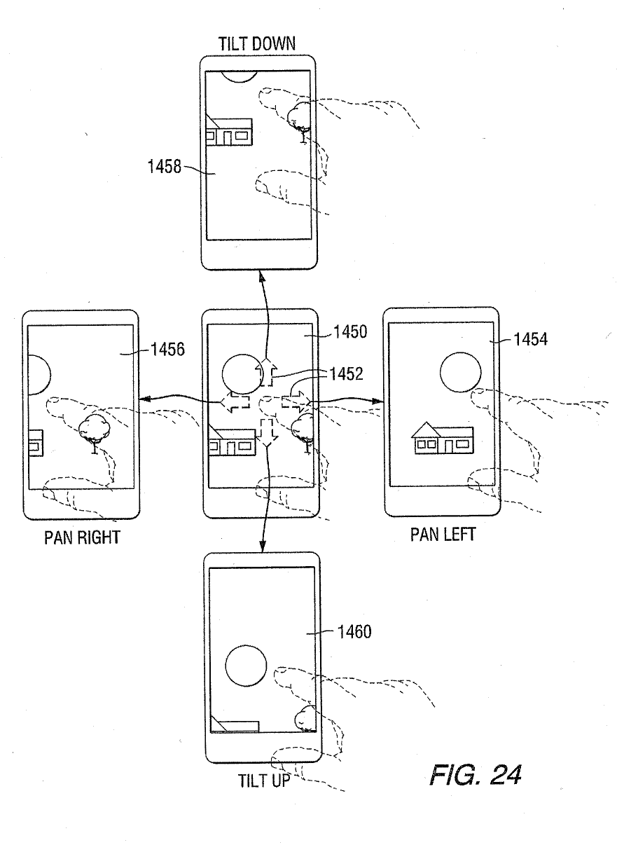

FIG. 24 illustrates pan and tilt functions in response to user commands. The mobile computing device includes a touch screen display 1450. A user can touch the screen and move in the directions shown by arrows 1452 to change the displayed image to achieve pan and/or tile function. In screen 1454, the image is changed as if the camera field of view is panned to the left. In screen 1456, the image is changed as if the camera field of view is panned to the right. In screen 1458, the image is changed as if the camera is tilted down. In screen 1460, the image is changed as if the camera is tilted up. As shown in FIG. 24, touch-based pan and tilt allows the user to change the viewing region by following single contact drag. The initial point of contact from the user's touch is mapped to a pan/tilt coordinate, and pan/tilt adjustments are computed during dragging to keep that pan/tilt coordinate under the user's finger.

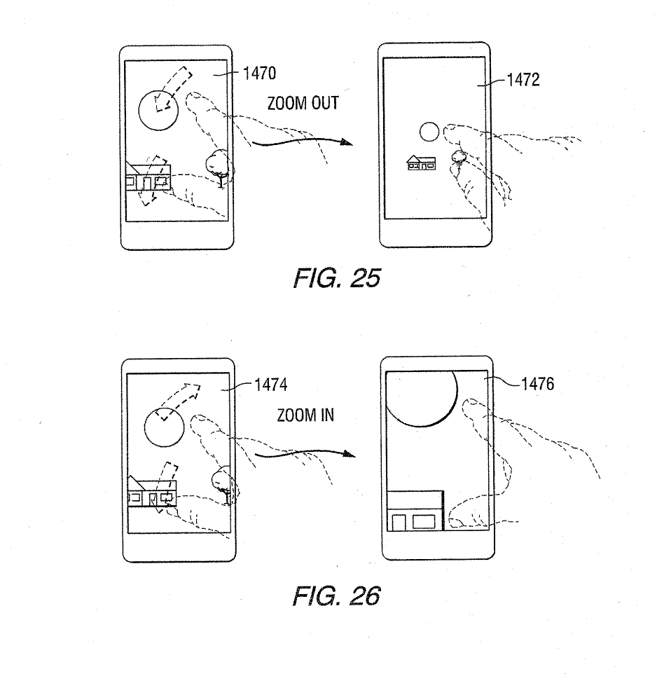

As shown in FIGS. 25 and 26, touch-based zoom allows the user to dynamically zoom out or in. Two points of contact from a user touch are mapped to pan/tilt coordinates, from which an angle measure is computed to represent the angle between the two contacting fingers. The viewing field of view (simulating zoom) is adjusted as the user pinches in or out to match the dynamically changing finger positions to the initial angle measure. As shown in FIG. 25, pinching in the two contacting fingers produces a zoom out effect. That is, an object in screen 1470 appears smaller in screen 1472. As shown in FIG. 26, pinching out produces a zoom in effect. That is, an object in screen 1474 appears larger in screen 1476.

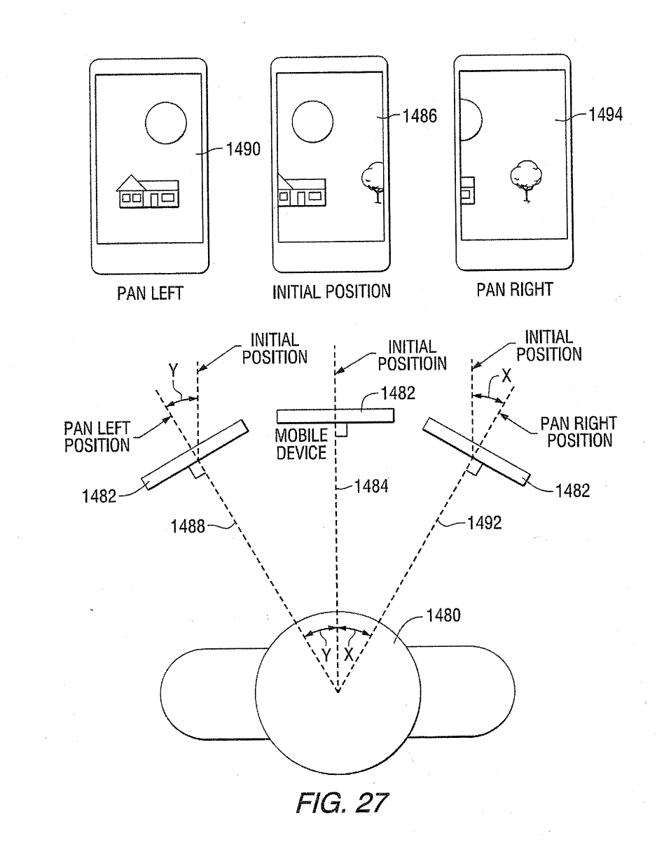

FIG. 27 illustrates an orientation-based pan that can be derived from compass data provided by a compass sensor in the computing device, allowing the user to change the displaying pan range by turning the mobile device. This can be accomplished by matching live compass data to recorded compass data in cases where recorded compass data is available. In cases where recorded compass data is not available, an arbitrary north value can be mapped onto the recorded media. When a user 1480 holds the mobile computing device 1482 in an initial position along line 1484, image 1486 is produced on the device display. When a user 1480 moves the mobile computing device 1482 in a pan left position along line 1488, which is offset from the initial position by an angle y, image 1490 is produced on the device display. When a user 1480 moves the mobile computing device 1482 in a pan right position along line 1492, which is offset from the initial position by an angle x, image 1494 is produced on the device display. In effect, the display is showing a different portion of the panoramic image capture by the combination of the camera and the panoramic optical device. The portion of the image to be shown is determined by the change in compass orientation data with respect to the initial position compass data.

Sometimes it is desirable to use an arbitrary north value even when recorded compass data is available. It is also sometimes desirable not to have the pan angle change 1:1 with the device. In some embodiments, the rendered pan angle may change at user-selectable ratio relative to the device. For example, if a user chooses 4× motion controls, then rotating the display device thru 90° will allow the user to see a full rotation of the video, which is convenient when the user does not have the freedom of movement to spin around completely.

In cases where touch-based input is combined with an orientation input, the touch input can be added to the orientation input as an additional offset. By doing so, conflict between the two input methods is avoided effectively.

On mobile devices where gyroscope data is available and offers better performance, gyroscope data which measures changes in rotation along multiple axes over time, can be integrated over the time interval between the previous rendered frame and the current frame. This total change in orientation can be added to the orientation used to render the previous frame to determine the new orientation used to render the current frame. In cases where both gyroscope and compass data are available, gyroscope data can be synchronized to compass positions periodically or as a one-time initial offset.

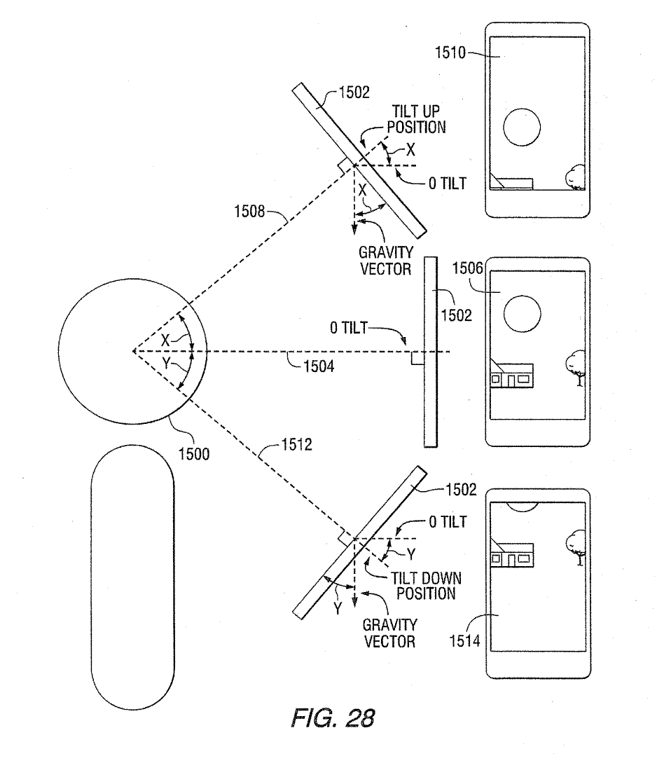

As shown in FIG. 28, orientation-based tilt can be derived from accelerometer data, allowing the user to change the displaying tilt range by tilting the mobile device. This can be accomplished by computing the live gravity vector relative to the mobile device. The angle of the gravity vector in relation to the device along the device's display plane will match the tilt angle of the device. This tilt data can be mapped against tilt data in the recorded media. In cases where recorded tilt data is not available, an arbitrary horizon value can be mapped onto the recorded media. The tilt of the device may be used to either directly specify the tilt angle for rendering (i.e. holding the phone vertically will center the view on the horizon), or it may be used with an arbitrary offset for the convenience of the operator. This offset may be determined based on the initial orientation of the device when playback begins (e.g. the angular position of the phone when playback is started can be centered on the horizon). When a user 1500 holds the mobile computing device 1502 in an initial position along line 1504, image 1506 is produced on the device display. When a user 1500 moves the mobile computing device 1502 in a tilt up position along line 1508, which is offset from the gravity vector by an angle x, image 1510 is produced on the device display. When a user 1500 moves the mobile computing device 1502 in a tilt down position along line 1512, which is offset from the gravity by an angle y, image 1514 is produced on the device display. In effect, the display is showing a different portion of the panoramic image captured by the combination of the camera and the panoramic optical device. The portion of the image to be shown is determined by the change in vertical orientation data with respect to the initial position compass data.

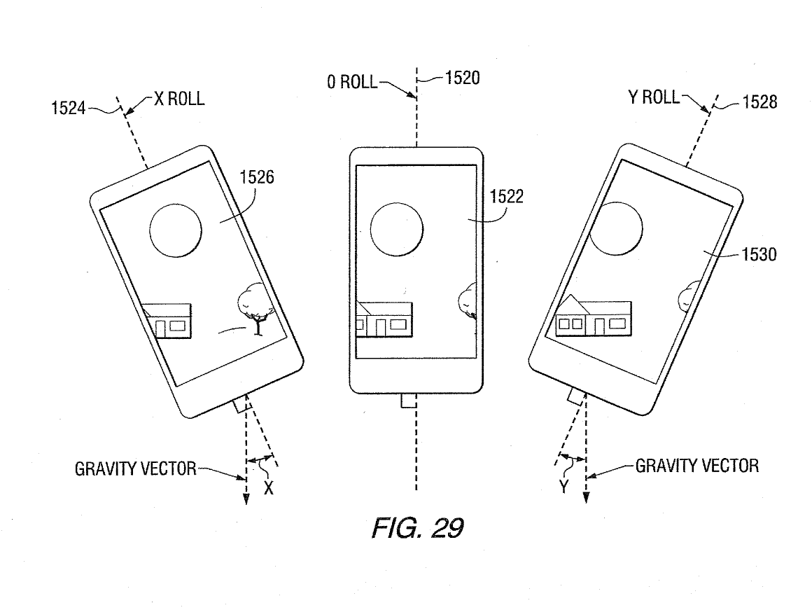

As shown in FIG. 29, automatic roll correction can be computed as the angle between the device's vertical display axis and the gravity vector from the device's accelerometer. When a user holds the mobile computing device in an initial position along line 1520, image 1522 is produced on the device display. When a user moves the mobile computing device to an x-roll position along line 1524, which is offset from the gravity vector by an angle x, image 1526 is produced on the device display. When a user moves the mobile computing device in a y-roll position along line 1528, which is offset from the gravity by an angle y, image 1530 is produced on the device display. In effect, the display is showing a tilted portion of the panoramic image captured by the combination of the camera and the panoramic optical device. The portion of the image to be shown is determined by the change in vertical orientation data with respect to the initial gravity vector.

The user can select from live view from the camera, videos stored on the device, view content on the user (full resolution for locally stored video or reduced resolution video for web streaming), and interpret/re-interpret sensor data. Proxy streams may be used to preview a video from the camera system on the user side and are transferred at a reduced image quality to the user to enable the recording of edit points. The edit points may then be transferred and applied to the higher resolution video stored on the camera. The high-resolution edit is then available for transmission, which increases efficiency and may be an optimum method for manipulating the video files.

The camera system 10 of the present invention may be used with various applications (“apps”). For example, an app can search for any nearby camera system and prompt the user with any devices it locates. Once a camera system has been discovered, a name may be created for that camera. If desired, a password may be entered for the camera Wi-Fi network also. The password may be used to connect a mobile device directly to the camera via Wi-Fi when no Wi-Fi network is available. The app may then prompt for a Wi-Fi password. If the mobile device is connected to a Wi-Fi network, that password may be entered to connect both devices to the same network.

The app may enable navigation to a “cameras” section, where the camera to be connected to Wi-Fi in the list of devices may be tapped on to have the app discover it. The camera may be discovered once the app displays a Bluetooth icon for that device. Other icons for that device may also appear (e.g., LED status, battery level and an icon that controls the settings for the device). With the camera discovered, the name of the camera can be tapped to display the network settings for that camera. Once the network settings page for the camera is open, the name of the wireless network in the SSID field may be verified to be the network that the mobile device is connected on. An option under “security” may be set to match the network's settings and the network password may be entered. Note some Wi-Fi networks will not require these steps. The “cameras” icon may be tapped to return to the list of available cameras. When a camera has connected to the Wi-Fi network, a thumbnail preview for the camera may appear along with options for using a live viewfinder or viewing content stored on the camera.

In situations where no external Wi-Fi network is available, the app may be used to navigate to the “cameras” section, where the camera to connect to may be provided in a list of devices. The camera's name may be tapped on to have the app discover it. The camera may be discovered once the app displays a Bluetooth icon for that device. Other icons for that device may also appear (e.g., LED status, battery level and an icon that controls the settings for the device). An icon may be tapped on to verify that Wi-Fi is enabled on the camera. Wi-Fi settings for the mobile device may be addressed in order to locate the camera in the list of available networks. That network may then be connected to. The user may then switch back to the app and tap “cameras” to return to the list of available cameras. When the camera and the app have connected, a thumbnail preview for the camera may appear along with options for using a live viewfinder or viewing content stored on the camera.

In certain embodiments, video can be captured without a mobile device. To start capturing video, the camera system may be turned on by pushing the power button. Video capture can be stopped by pressing the power button again.

In other embodiments, video may be captured with the use of a mobile device paired with the camera. The camera may be powered on, paired with the mobile device and ready to record. The “cameras” button may be tapped, followed by tapping “viewfinder.” This will bring up a live view from the camera. A record button on the screen may be tapped to start recording. To stop video capture, the record button on the screen may be tapped to stop recording.

To playback and interact with a chosen video, a play icon may be tapped. The user may drag a finger around on the screen to change the viewing angle of the shot. The video may continue to playback while the perspective of the video changes. Tapping or scrubbing on the video timeline may be used to skip around throughout the video.

Firmware may be used to support real-time video and audio output (e.g., via USB), allowing the camera to act as a live web-cam when connected to a PC. Recorded content may be stored using standard DCIM folder configurations. A YOUTUBE mode may be provided using a dedicated firmware setting that allows for “YouTube Ready” video capture, including metadata overlay for direct upload to YOUTUBE. Accelerometer activated recording may be used. A camera setting may allow for automatic launch of recording sessions when the camera senses motion and/or sound. A built-in accelerometer, altimeter, barometer and GPS sensors may provide the camera with the ability to produce companion data files in .csv format. Time-lapse, photo and burst modes may be provided. The camera may also support connectivity to remote Bluetooth microphones for enhanced audio recording capabilities.

The modular panoramic camera system 10 of the present invention has many uses. The camera may be hand-held or mounted on any support structure, such as a person or object (either stationary or mobile). In one mode, primary and secondary cameras 20, 120 are mounted to the base module handle 12 for 360°×360° capture, where the handle 12 may be hand held or fixed mount through the mounting hole. In another mode, the primary camera module 20 may be mounted to an auxiliary base 70 to form a panoramic camera with a field of view of, for example, 360°×240° or 360°×270°. In another mode, the primary camera module 20 may be mounted to a pad 50, and the camera module 20 may receive its operating power through a connector 60. Such a configuration is suitable for wall-mounted surveillance or any other application where the camera module 20 is mounted on a flat surface and constantly powered. The field of view could possibly be constrained by the flat surface, resulting in a 360°×180° field of view.

Examples of some possible applications and uses of the system in accordance with embodiments of the present invention include: motion tracking; social networking; 360° mapping and touring; security and surveillance; and military applications.

For motion tracking, the processing software can be written to detect and track the motion of subjects of interest (people, vehicles, etc.) and display views following these subjects of interest.

For social networking and entertainment or sporting events, the processing software may provide multiple viewing perspectives of a single live event from multiple devices. Using geo-positioning data, software can display media from other devices within close proximity at either the current or a previous time. Individual devices can be used for n-way sharing of personal media (much like YOUTUBE or FLICKR). Some examples of events include concerts and sporting events where users of multiple devices can upload their respective video data (for example, images taken from the user's location in a venue), and the various users can select desired viewing positions for viewing images in the video data. Software can also be provided for using the apparatus for teleconferencing in a one-way (presentation style—one or two-way audio communication and one-way video transmission), two-way (conference room to conference room), or n-way configuration (multiple conference rooms or conferencing environments).

For 360° mapping and touring, the processing software can be written to perform 360° mapping of streets, buildings, and scenes using geospatial data and multiple perspectives supplied over time by one or more devices and users. The apparatus can be mounted on ground or air vehicles as well, or used in conjunction with autonomous/semi-autonomous drones. Resulting video media can be replayed as captured to provide virtual tours along street routes, building interiors, or flying tours. Resulting video media can also be replayed as individual frames, based on user requested locations, to provide arbitrary 360° tours (frame merging and interpolation techniques can be applied to ease the transition between frames in different videos, or to remove temporary fixtures, vehicles, and persons from the displayed frames).

For security and surveillance, the apparatus can be mounted in portable and stationary installations, serving as low profile security cameras, traffic cameras, or police vehicle cameras. One or more devices can also be used at crime scenes to gather forensic evidence in 360° fields of view. The optic can be paired with a ruggedized recording device to serve as part of a video black box in a variety of vehicles; mounted either internally, externally, or both to simultaneously provide video data for some predetermined length of time leading up to an incident.

For military applications, man-portable and vehicle mounted systems can be used for muzzle flash detection, to rapidly determine the location of hostile forces. Multiple devices can be used within a single area of operation to provide multiple perspectives of multiple targets or locations of interest. When mounted as a man-portable system, the apparatus can be used to provide its user with better situational awareness of his or her immediate surroundings. When mounted as a fixed installation, the apparatus can be used for remote surveillance, with the majority of the apparatus concealed or camouflaged. The apparatus can be constructed to accommodate cameras in non-visible light spectrums, such as infrared for 360° heat detection.

Whereas particular embodiments of this invention have been described above for purposes of illustration, it will be evident to those skilled in the art that numerous variations of the details of the present invention may be made without departing from the invention.

What is claimed is:

1. A modular panoramic camera system comprising:
a base module;
a first panoramic camera module releasably attached to the base module and including a first processor; and
a second panoramic camera module attached to the base module,
wherein the first processor is operable to synchronize image data generated from the second panoramic camera module with image data generated by the first panoramic camera module to produce combined image data representing a 360° field of view.

2. The modular panoramic camera system of claim 1, wherein the second panoramic camera module comprises a second processor.

3. The modular panoramic camera system of claim 2, wherein the first processor is a main processor, and the second processor is a secondary processor.

4. The modular panoramic camera system of claim 2, wherein the first and second processors are dynamically switchable from being a main processor to being a secondary processor.

5. The modular panoramic camera system of claim 1, wherein the first and second panoramic camera modules have field of view angles greater than 200°.

6. The modular panoramic camera system of claim 5, wherein the field of view angles are greater than 220°.

7. The modular panoramic camera system of claim 5, wherein the field of view angles are from 240° to 270°.

8. The modular panoramic camera system of claim 1, wherein the second panoramic camera module is releasably attached to the base module.

9. The modular panoramic camera system of claim 8, wherein the first and second panoramic camera modules are structured and arranged to be releasably attachable to each other.

10. The modular panoramic camera system of claim 1, wherein the base module comprises at least one electrical contact releasably engageable with at least one electrical contact on the first panoramic camera, and at least one electrical contact releasably engageable with at least one electrical contact on the second panoramic camera module.

11. The modular panoramic camera system of claim 1, wherein the first panoramic camera module comprises a housing having a rake angle that is outside a field of view angle of the first panoramic camera module.

12. The modular panoramic camera system of claim 1, wherein the second panoramic camera module comprises a housing having a rake angle that is outside a field of view angle of the second panoramic camera module.

13. The modular panoramic camera system of claim 1, wherein the first panoramic camera module is structured and arranged for connection to a charger pad.

14. The modular panoramic camera system of claim 13, wherein the charger pad comprises at least one electrical contact releasably engageable with at least one electrical contact on the base module.

15. The modular panoramic camera system of claim 1, wherein the first panoramic camera module is structured and arranged to be releasably attachable to an auxiliary base module.

16. The modular panoramic camera system of claim 15, wherein the auxiliary base module comprises at least one electrical contact releasably engageable with at least one electrical contact on the base module.

17. The modular panoramic camera system of claim 1, wherein the first processor synchronizes audio data with the combined image data.

18. The modular panoramic camera system of claim 1, wherein at least one of the first panoramic camera module, the second panoramic camera module, and the base module includes a microphone.

19. The modular panoramic camera system of claim 1, wherein the first panoramic camera module and the second panoramic camera module each include at least one microphone, and audio data generated by the microphones is synchronized.

20. The modular panoramic camera system of claim 19, wherein the audio data is synchronized in the first processor.

21. The modular panoramic camera system of claim 1, further comprising at least one motion sensor contained in at least one of the base module, the first panoramic camera module, and the second panoramic camera module.

22. The modular panoramic camera system of claim 21, wherein the at least one motion sensor comprises an accelerometer or a gyroscope.
